(19) United States
(12) Patent Application Publication
(10) Pub. No.: US 2024/0425339 A1
(43) Pub. Date: Dec. 26, 2024

(54) COMPACT CAPPING SYSTEM FOR MODULAR PRESCRIPTION SYSTEMS

(71) Applicant: Innovation Associates Inc., Johnson City, NY (US)

(72) Inventors: David Royce, Binghamton, NY (US); Mark Jones, New Milford, PA (US); Fletcher Chapin, JR., Maine, NY (US); Ryan Van Tessel, Friendsville, PA (US); Greg Greive, Meshoppen, PA (US); Andrew Hoover, Newark Valley, NY (US); Matt Rogers, Binghamton, NY (US); Fletcher Chapin, SR., Maine, NY (US)

(21) Appl. No.: 18/828,771

(22) Filed: Sep. 9, 2024

Related U.S. Application Data
(63) Continuation of application No. 17/523,017, filed on Nov. 10, 2021, now abandoned.
(60) Provisional application No. 63/111,742, filed on Nov. 10, 2020.

(51) Int. Cl. B67B 3/20; B67B 3/22; B67B 3/26

(52) U.S. Cl. CPC B67B 3/2013; B67B 3/22; B67B 3/26

(57) ABSTRACT

Methods and systems for capping prescription medication bottles are provided. In one embodiment, a capping system is provided that includes a first position at which uncapped bottles containing fulfilled prescriptions are received. The capping system also includes a second position at which uncapped bottles are capped. The second position may include a capping member that is axially aligned with a vertical centerline of uncapped bottles located at the second position. The capping system may also include an index wheel configured to support bottles within the capping system. The index wheel may be rotatable to convey uncapped bottles from the first position to the second position. The capping system may further include a cap track that provides caps to the capping member.

### PRIORITY CLAIM

This application is a continuation application of U.S. patent application Ser. No. 17/523,017, filed on Nov. 10, 2021, which claims priority to and the benefit of U.S. Provisional Patent Application Ser. No. 63/111,742, filed on Nov. 10, 2020, the entire disclosure of which is hereby incorporated by reference.

### BACKGROUND

Automated systems may be used to prepare and fill medication prescriptions for individuals. For example, automated machines may be used to dispense particular quantities of different types of pills or other medications to fulfill prescriptions. Additionally, automated systems may be used to collect counted pills in containers, label the containers (e.g., with patient information or prescription information), and/or close the containers (e.g., by fastening caps to the containers). The containers may then be mailed to pharmacies or directly to patients.

### SUMMARY

The present disclosure presents new and innovative systems and methods for capping medication bottles. In one embodiment, a capping system is provided that includes a first position at which uncapped bottles containing fulfilled prescriptions are received. The fulfilled prescriptions include pills, for example. The capping system may also include a second position at which uncapped bottles are capped. The second position may include a capping member that is axially aligned with a vertical centerline of uncapped bottles located at the second position. The capping system may also include an index wheel configured to support bottles within the capping system. The index wheel may be rotatable to convey uncapped bottles from the first position to the second position. The capping system may further include a cap track that provides caps to the capping member.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates an exterior view of a prescription filling system in a compact configuration, according to an exemplary embodiment of the present disclosure.

FIG. 2 illustrates an interior view of a prescription filling system in a compact configuration, according to an exemplary embodiment of the present disclosure.

FIG. 3 illustrates an overhead schematic view of a prescription filling system, according to an exemplary embodiment of the present disclosure.

FIG. 4 illustrates an exterior view of a prescription filling system in a fully expanded configuration, according to an exemplary embodiment of the present disclosure.

FIGS. 5A-5B illustrate a capping system, according to an exemplary embodiment of the present disclosure.

### DETAILED DESCRIPTION OF EXAMPLE EMBODIMENTS

Different prescription filling facilities may fulfill different quantities of prescription requests for medication, or may fulfill prescription requests for different amounts of discrete types of prescription drugs. Accordingly, different prescription filling systems are typically provided in various sizes that include equipment designed to meet these requirements. However, these prescription filling systems are typically created as self-contained, all-encompassing systems. As a particular user's prescription filling needs grow over time (e.g., as a business expands), users may be required to purchase additional machines that replace smaller machines. Such expansion can be wasteful as smaller machines go unused or as customers are required to repurchase certain redundant components between the various machines. Accordingly, there exists a need for a prescription filling system that can be expanded easily as users' capacity grows.

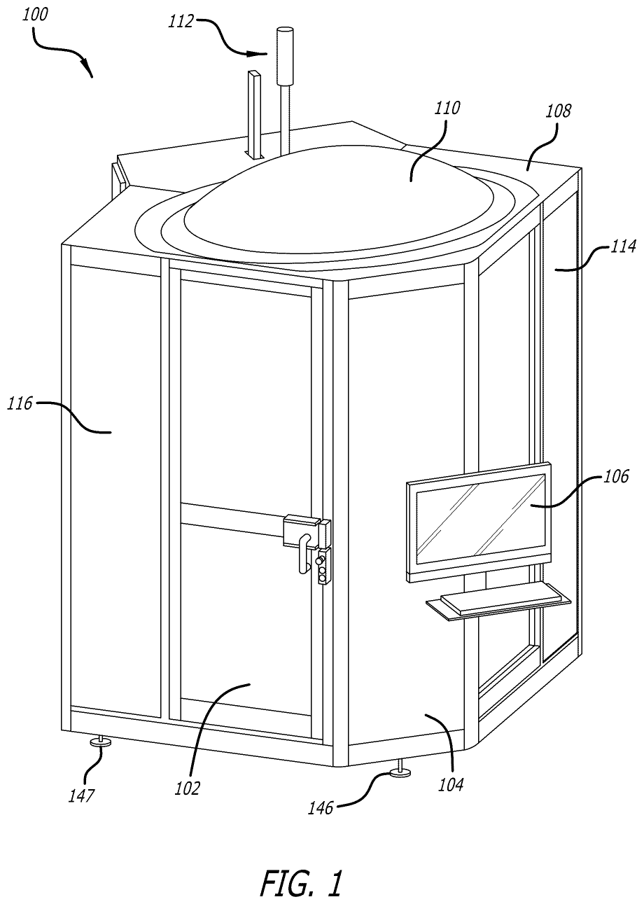

One solution to this problem is to provide a modular prescription filling system. For example, modular prescription filling systems may be expandable from compact configurations to larger configurations. FIGS. 1-4 depict one such modular prescription filling system, which may be expanded from a smaller compact configuration to a larger expanded configuration.

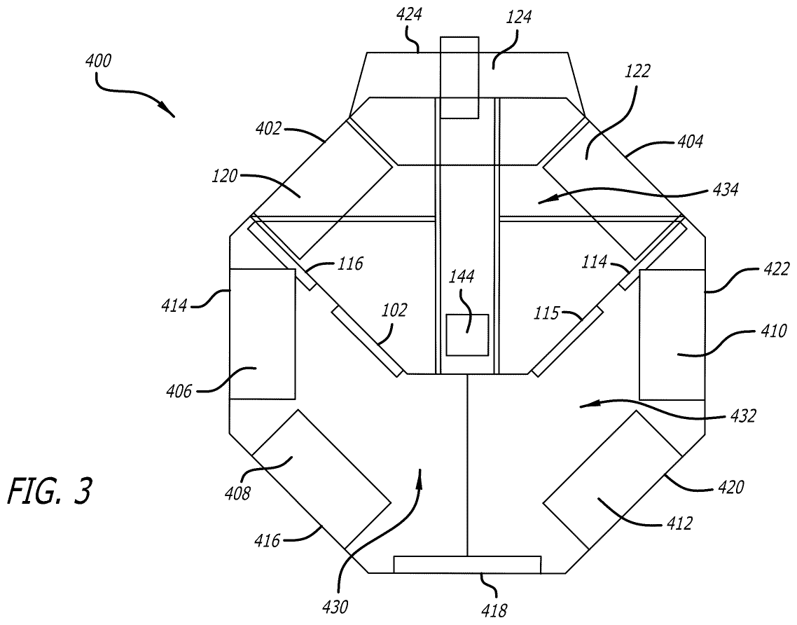

In particular, FIG. 1 illustrates an exterior view of a prescription filling system 100 in a compact configuration, according to an exemplary embodiment of the present disclosure. The prescription filling system 100 includes several exterior wall portions 104, 114, 115 (shown in FIG. 3), and 116. As explained in more detail below, the exterior wall portions 104, 114, 115, and 116 of the prescription filling system 100 may be formed as part of an octagonal shape surrounding a center point. When configured in this way, the prescription filling system 100 may be expandable to include additional exterior wall sections, and may thereby be expandable to contain additional equipment, as explained below. In certain instances, the wall portions 104, 114, 115, 116 may store other equipment used by the prescription filling system 100. For example, the prescription filling system 100 includes a computer terminal 106, which may be configured to control or monitor prescription filling operations performed by the prescription filling system 100. For example, the computer terminal may contain a processor and a memory configured to execute software to monitor or control prescription filling operations. The prescription filling system 100 also includes a roof 108 that includes a convex partition 110. The roof 108, coupled with the wall portions 104, 114, 115, 116, may form a sealed environment within the prescription filling system 100. The prescription filling system 100 also includes a door 102, which may be used to enter or exit the prescription filling system 100.

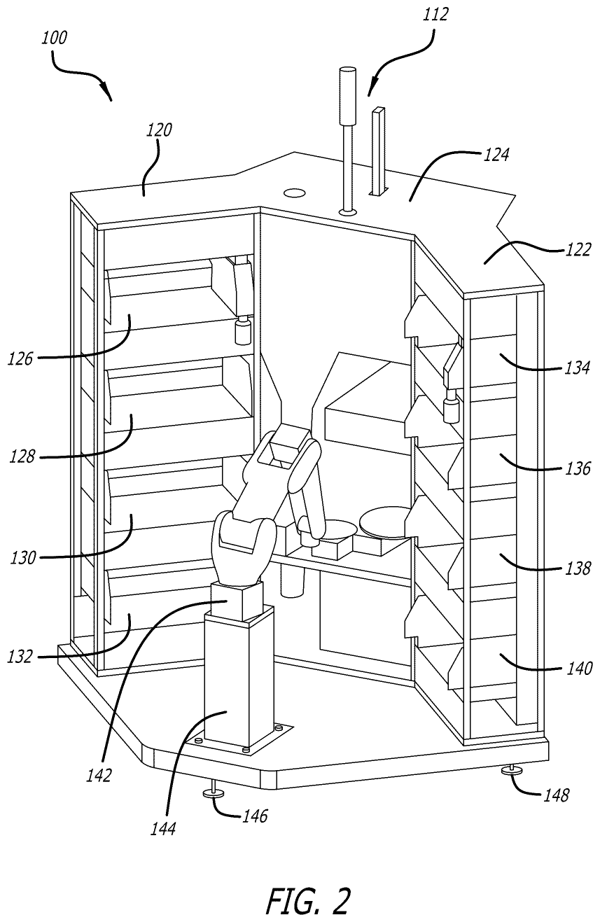

Turning to FIG. 2, the interior of the prescription filling system 100 includes shelves 120 and 122 and a supplementary system 124. The shelves 120 and 122 include equipment brackets 126, 128, 130, 132, 134, 136, 138, and 140. The equipment brackets 126, 128, 130, 132, 134, 136, 138, and 140 may be configured to hold one or more machines or subsystems used by the prescription filling system 100. For example, the equipment brackets 126, 128, 130, 132, 134, 136, 138, and 140 may be configured to securely attach to and hold in place particular types of machinery. The equipment brackets 126, 128, 130, 132, 134, 136, 138, and 140 may be configured to securely hold machines of various sizes. The equipment brackets 126, 128, 130, 132, 134, 136, 138, and 140 within the shelves 120 and 122 may also be replaceable to accept equipment brackets designed to hold equipment of a different size.

The system 100 also includes a supplementary system 124. The supplementary system 124 may integrate with a ventilation system 112. For example, the filtration system may include a HEPA filtering module that connects to an air intake or an air outlet of the ventilation system 112. As discussed further below, the supplementary system 124 may also include a capping system. For example, the capping system may store caps (e.g., for pill containers of particular sizes, for particular types of caps/threading). Caps may then be applied to pill containers by the capping system.

The system 100 includes a robotic arm 142 configured to interact with different systems stored within the shelves 120 and 122 and/or different systems of the supplementary system 124. For example, a controller of the robotic arm 142 may receive a prescription fulfillment request (e.g., via the computer terminal 106). In response, the robotic arm 142 may grab a pill container (e.g., from a pill container storage system located within the supplementary system 124 and/or within one of the equipment brackets 126, 128, 130, 132, 134, 136, 138, and 140) and may interact with a pill dispensing machine located on one of the equipment brackets 126, 128, 130, 132, 134, 136, 138, and 140 to receive an appropriate number of pills specified within the prescription fulfillment request. Once the pills are received within the pill container, the robotic arm 142 may grab a cap from a capping system and may apply the cap to the top of the pill container, sealing the medication.

FIG. 3 illustrates an overhead schematic view 400 of the prescription filling system 100 of FIGS. 1 and 2, according to an exemplary embodiment of the present disclosure. The overhead schematic view 400 depicts an overhead view of the prescription filling system 100, along with additional (darkened) depictions of various expandable configurations for prescription filling systems. As described previously, the compact configuration includes shelves 120 and 122, a supplementary system 124, wall portions 104, 114, 115, and 116, and a door 102. From the compact configuration, prescription filling systems may be expandable to include additional space for additional equipment. In particular, the prescription filling system may be expandable to a fully expanded configuration with an octagonal shape, as depicted in the overhead schematic view 400. The octagonal shape is formed by the exterior walls 402, 404, 414, 416, 418, 420, and 422 and an exterior wall portion of the supplementary system 124. In such an expanded configuration, one or more of the wall portions 104, 114, 115, and 116 and the door 102 may be omitted.

In the fully expanded configuration, a prescription filling system may include one or more additional shelves 406, 408, 410, and 412 for at least a subset of the additional exterior walls 414, 416, 420, and 422. The prescription filling system may further include a door (e.g., at the external wall 418), which may be used to enter the prescription filling system 100, similar to the door 102. In either configuration, the prescription filling system 100 may include a pedestal 144, which may support the robotic arm 142 used to fulfill prescription requests, as discussed above. In particular, the pedestal 144 may be positioned such that the pedestal 144 is at or near the center of the prescription fulfillment system 100 in the expanded configuration.

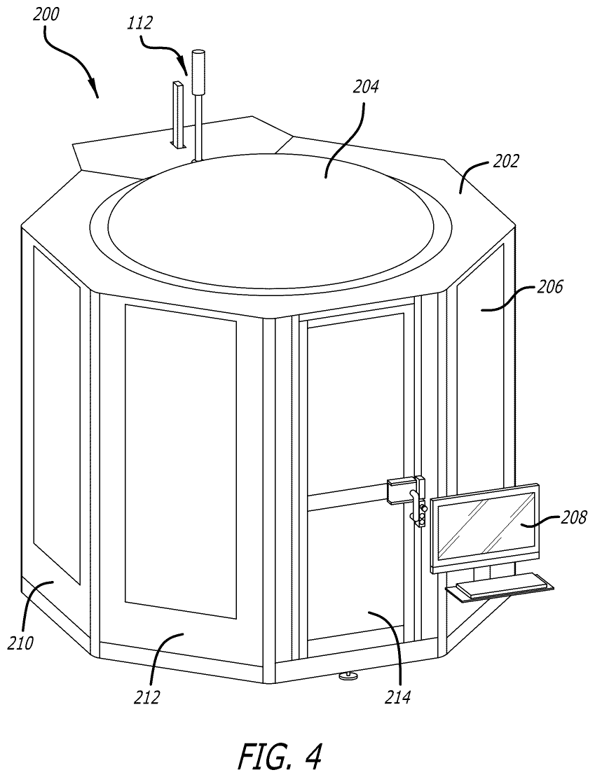

FIG. 4 depicts one such prescription filling system 200 in a fully expanded configuration, according to an exemplary embodiment of the present disclosure. The prescription filling system 200 includes wall portions 210, 212, and 206. The prescription fulfillment system 200 also includes a door 214, similar to the door 102 of FIG. 1. The prescription filling system 200 also includes a ventilation system 112 and a computer terminal 208, which may be identical to the computer terminal 106. On top, the prescription filling system 200 includes a roof 202 and a convex portion 204.

Starting from a compact configuration, capacity for a prescription fulfillment system may be expanded on a modular basis. In particular, the fully expanded configuration may comprise three separate modules: a primary module 434 and two expansion modules 430 and 432. The primary module 434 may contain the pedestal 144 and may optionally contain the supplementary system 124. A first expansion module 430 may include the exterior walls 414 and 416 and the shelves 406 and 408. A second expansion module 432 may contain the exterior walls 420 and 422 and the shelves 410 and 412. The expansion modules 430 and 432 may be added to a primary module 434 one at a time as needed to gradually expand the prescription fulfillment system 200. In this manner, the modules and associated components (e.g., shelves, equipment brackets, etc.) provide for a modularly expandable prescription filling system that can be initially configured at a lower capacity (e.g., using the primary module 434) and can be easily expanded using identical expansion modules as capacity needs increase.

Furthermore, within each of the modules, the specific capabilities of the system may be customized for particular deployment needs. In particular, the combination of the shelves and equipment brackets contained therein enable quick adjustment of the specific equipment included within the prescription fulfillment system (e.g., types of machines, capacities of machines, number of machines, etc.) accessible via the robotic arm 142 or other fulfillment mechanism of the prescription filling system. In this manner, not only can the capacity of the prescription filling system be customized and progressively expanded on a modular basis, but also the capabilities may be expanded and/or custom-tailored as needed.

Modular prescription filling systems similar to those discussed above and depicted in FIGS. 1-4 are further detailed in U.S. Provisional Application No. 63/089,318, entitled “MODULAR PRESCRIPTION FILLING SYSTEM AND FACILITIES” and filed on Oct. 8, 2020, which is hereby incorporated entirely by reference.

To properly fill prescriptions, capping systems may be necessary to seal bottles containing filled prescription orders. However, modular prescription filling systems may fulfill many types of prescription requests for many types or amounts of medication. Such changes may require different types of caps or capping systems. For example, different medications may be stored in different types of bottles, and the different bottles may use different types of caps. As another example, larger quantities of medication may be stored in larger bottles, which use larger caps than bottles used for smaller amounts of medication. Accordingly, modular prescription filling systems need robust capping systems that are able to handle different types of caps and/or bottles and can be quickly updated based on changing uses for the modular prescription filling systems.

Such capping systems may be provided in supplementary systems, such as the supplementary system 124. In particular, capping systems may be designed to work with robotic arms 142. Furthermore, capping systems configured to work within supplementary systems 124 may have a reduced size to ensure proper accommodations within the supplementary systems 124 (e.g., to avoid interfering with other aspects of the supplementary system, such as ventilation systems).

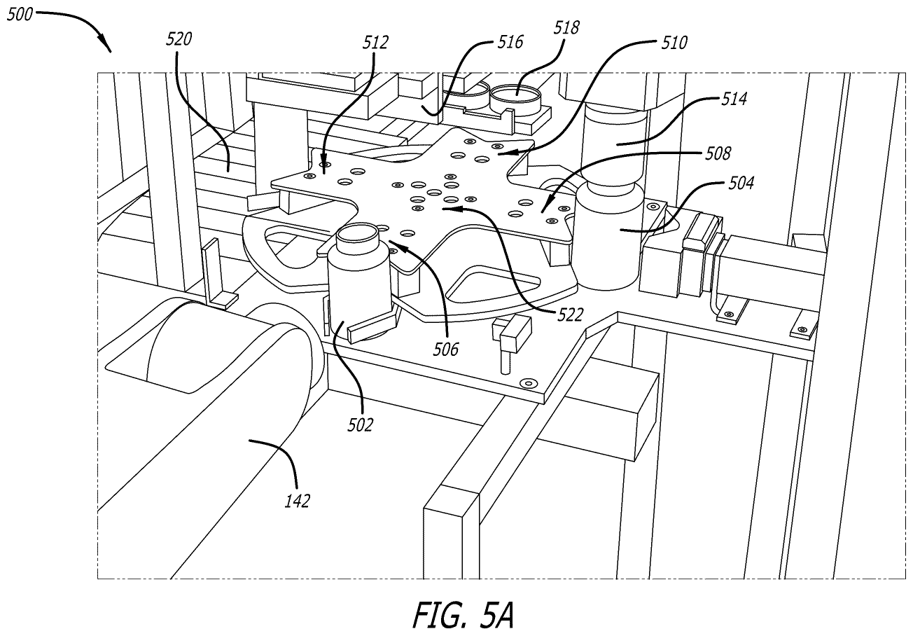

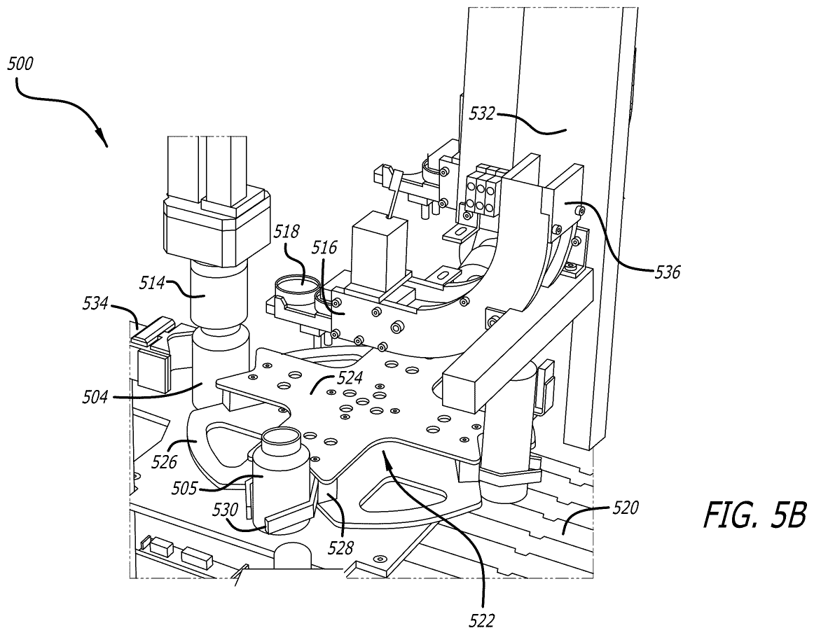

FIGS. 5A-5B illustrate a capping system 500, according to an exemplary embodiment of the present disclosure. In particular, FIG. 5A depicts a front view of the capping system 500 and FIG. 5B depicts a rear view of the capping system 500. The capping system 500 may be configured for use in a modular prescription filling system. In particular, the capping system 500 may be configured to operate within a supplementary system 124 of the prescription filling system, such as the systems 100 and/or 200.

The capping system 500 includes an index wheel 522. The index wheel 522 may be configured to receive bottles 502, 504, and 505 from a robotic arm 142. For example, the robotic arm 142 may place the bottles 502, 504, and 505 on the index wheel 522 after filling the bottles with a designated prescription. The index wheel 522 includes an upper member 524 and a lower member 526. The upper and lower members 524 and 526 may be configured, in combination, to support bottles 502, 504, and 505 received by the capping system 500. In particular, the lower member 526 includes bottom supports 530 that support the bottles 502, 504, and 505 from the bottom and the upper member 524 includes side supports 528 that support the bottles 502, 504, and 505 from the side.

In the illustrated example, the lower member 526 includes four bottom supports 530 for supporting four bottles. Further, the upper member 524 includes four side supports 528 that are aligned with the bottom supports 530 for supporting or at least partially cradling the bottles. In other examples, the lower membrane 526 includes fewer bottom supports 530, such as one or two supports. Alternatively, the lower membrane 526 includes additional bottom supports 530, such as five, six, or eight bottom supports 530. The upper member 524 may also have fewer or additional side supports 528. For weight distribution, the bottom supports 530 and the side supports 528 may be evenly positioned around a perimeter respectively of the lower member 526 or the upper member 524.

The index wheel 522 may rotate to move the bottles 502, 504, and 505 through multiple positions. In particular, the index wheel 522 may rotate the bottles 502, 504, and 505 from a first position 506 to a second position 508, and then to a third position 510 and finally to a fourth position 512. For example, a bottle 502 may be received at the first position 506 from the robotic arm 142. The bottle 502 may then be rotated to the second position 508 for capping. The bottle 502 may then be rotated to the third position 510. At the third position 510, a cap already fastened to the bottle at the second position 508 may be optionally press-fit to the bottle 502. For example, the third position 510 may optionally include a pressing cylinder (not depicted). The pressing cylinder may press vertically down onto the top of the cap that is on the bottle 502. Certain caps, in response to such vertical pressure, may include a portion (e.g., an inner portion) that snaps down in response to such pressure, securely attaching the cap to the bottle. In certain such implementations, the press fitting of caps may be performed in addition to or instead of rotating the caps to fasten the caps to the bottle 502. The bottle 502 may be finally rotated to the fourth position 512. At the fourth position 512, the bottle may exit the capping system 500 via a conveyor belt 520. The fulfilled and capped prescription may then be conveyed away from the capping system 500 and/or the prescription filling system 100, 200 for further processing (e.g., for shipping, customer pickup, pharmacist review, etc.).

Focusing on the first position 506, when a bottle 502, 504, and/or 505 is received from the robotic arm 142, a camera may capture an image of the bottle 502. For example, an image may be captured of the contents of the bottle 502 and/or an exterior of the bottle (e.g., a label or other identifier on the bottle). These images may be used by the computer terminal 106 to confirm visually that the correct prescription was fulfilled for the bottles 502, 504, and 505. For example, the images may be analyzed by one or more computerized image processing techniques or systems to confirm, for example, a correct quantity, size, color, and/or type, of pills are included within the bottle.

The bottles 502, 504, and 505 are capped at the second position 508. In particular, the second position 508 includes a capping member 514 configured to fasten a cap to each of the bottles 502, 504, and 505. In particular, the capping member 514 is axially aligned with a vertical centerline of each bottle 502, 504, and 505 when located at the second position 508. The second position 508 may also include an additional side support member 534, which may provide additional lateral support to the bottles 502, 504, and 505 during capping. In particular, the side support member 534 may be configured to press against or otherwise individually cradle the bottles 502, 504, and 505 during capping. Additionally or alternatively, the side support member 534 may be statically positioned to allow the bottles 502, 504, and 505 to rotate around the index wheel 522, but to prevent tipping of the bottles 502, 504, and 505 at the second position 508 (e.g., caused by motion of the capping member 514).

The capping member 514 may cooperate with a cap track 516. In particular, the capping member 514 may be configured to grab a cap 518 from the cap track 516, place the cap 518 on top of the bottle 502, 504, and 505, and rotate until the cap 518 is secured on the bottle 502, 504, and 505 (e.g., for a predetermined number of rotations, until a predetermined torque is reached). In particular, the capping member 514 may move vertically up from the top of a bottle that has been capped, move laterally until located above the cap 518, move vertically down to grab the cap 518, and reverse the process to place the cap s518 on top of a bottle 502, 504, and 505 in the second position 508. In particular, while the capping member 514 grabs the cap 518, the index wheel 522 may rotate (as instructed by a controller of the computer terminal 106), advancing each bottle 502, 504, and 505 on the index wheel 522 by one position. For example, a newly-received bottle 502 in the first position 506 may be rotated to the second position 508 to be capped by the capping member 514 using the cap 518 grabbed by the capping member 514.

The cap track 516 is supplied by a cap supply track 532. The cap supply track 532 may store many caps 518 for use by the capping member 514 (e.g., tens of caps, hundreds of caps). For example, the cap supply track 532 may receive caps from outside of a prescription filling system 100, 200. In certain implementations, the cap track 516 may be quickly replaceable. For example, the cap track 516 may be detached from the cap supply track 532 at the joining point 536. The cap track 516 may then be substituted for a different size of cap track. For example, the cap track 516 may be replaced for a cap track using smaller caps, larger caps, different types of caps (e.g., bigger caps). Similarly, the capping member 514 may be exchanged for a capping member that uses different types of caps. In this way, the capping system 500 may be quickly adjusted to meet the requirements of a modular prescription filling system 100, 200. For example, a prescription filling system 100, 200 may be updated from fulfilling small prescription orders (e.g., 10-50 pills) to fulfilling large prescription orders (e.g., 50-200 pills). The large prescription orders may utilize larger bottles, which require larger caps. Accordingly, the capping system 500 may be updated with a cap track operating with large caps.

Furthermore, although not depicted, in certain implementations, the capping system 500 may include multiple cap tracks. For example, the cap tracks 516 may be parallel to one another within the capping system 500 and may be supplied by multiple cap supply tracks 532. The capping member 514 may be configured to grab a cap of a corresponding size for each bottle. For example, the image captured at the first position 506 may be used to identify size of the bottle, and the capping member 514 may grab a corresponding cap based on the determined size of the bottle. In some embodiments, a sensor may be located at the first position to detect a size, diameter, and/or weight of the bottle. The detected size, diameter, and/or weight may be used by a controller or the computer terminal 106 for selecting a cap size.

Once a bottle 502, 504, and/or 505 is capped, the bottle may rotate through the third position 510 and the fourth position 512 before exiting the capping system. As explained above, the bottles 502, 504, and 505 may exit the capping system 500 by the conveyor belt 520, which may carry the bottles 502, 504, and 505 out of the capping system 500 for further processing.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A capping system for use in a modular prescription medication filling system, the capping system comprising:
a first position in which an uncapped bottle containing a fulfilled medication prescription is received;
a second position in which the uncapped bottle is capped with a cap, the second position comprising a capping member axially aligned with a vertical centerline of the uncapped bottle located at the second position;
a third position in which the cap is press-fit to the bottle, the third position comprising a pressing cylinder that is configured to press vertically down onto a top of the respective cap causing the cap to snap downward to securely attach to the bottle;
a fourth position in which the capped bottle is removed to a conveyor belt, wherein the first position, the second position, the third position, and the fourth position are located 90 degrees from each other;
an index wheel configured to support bottles within the capping system, and rotatable to convey the uncapped bottle from the first position to the second position, the index wheel configured to have four bottle supports that are located 90 degrees from each other to correspond to the first through fourth positions; and
a cap track that provides caps of a specified size to the capping member.

2. The capping system of claim 1, wherein the index wheel includes:
a lower member that includes at least one bottom support that is configured to contact a bottom of the bottle; and
an upper member that includes at least one side support that is configured to contact or partially cradle a side of the bottle.

3. The capping system of claim 2, wherein the lower member includes four bottom supports that are positioned along a perimeter of the index wheel and the upper member includes four side supports that are positioned along a perimeter of the index wheel.

4. The capping system of claim 3, wherein the four bottom supports are respectively aligned with the four side supports.

5. The capping system of claim 2, further comprising an additional side support member located at the second position to provide lateral support to the bottle during capping.

6. The capping system of claim 5, wherein the additional side support member is operable with the side support at the second position to cradle the bottle from opposing sides.

7. The capping system of claim 1, wherein the capping member is configured to rotate the cap to fasten the cap to the bottle.

8. The capping system of claim 1, wherein the capping member is configured to:
move vertically to retrieve the cap from the cap track;
move laterally between the second position and the cap track; and
move vertically to place the cap on the bottle.

9. The capping system of claim 10, wherein the capping member is controlled to obtain the cap from the cap track while the index wheel is rotated to move the bottle from the first position to the second position.

10. The capping system of claim 1, further comprising:
a camera located at the first position for recording an image of at least one of contents of the bottle or a label or other identifier on an exterior of the bottle,
wherein the controller is further configured to confirm visually that the correct prescription was fulfilled for the bottle using the recorded image.

11. A capping system comprising:
a first position in which an uncapped bottle containing a fulfilled prescription is received;
a second position in which the uncapped bottle is capped with a cap, the second position comprising a capping member axially aligned with a vertical centerline of the uncapped bottle located at the second position;
a third position in which the cap is press-fit to the bottle;
a fourth position in which the capped bottle is removed to a conveyor belt, wherein the first position, the second position, the third position, and the fourth position are located 90 degrees from each other;
an index wheel configured to support bottles within the capping system, and rotatable to convey the uncapped bottle from the first position to the second position, the index wheel configured to have four bottle supports that are located 90 degrees from each other to correspond to the first through fourth positions; and
a cap track that provides caps to the capping member.

12. The capping system of claim 11, wherein the third position comprises a pressing cylinder that is configured to press vertically down onto a top of the respective cap causing the cap to snap downward to securely attach to the bottle.

13. The capping system of claim 12, wherein the index wheel includes:
a lower member that includes at least one bottom support that is configured to contact a bottom of the bottle; and
an upper member that includes at least one side support that is configured to contact or partially cradle a side of the bottle.

14. The capping system of claim 13, wherein the lower member includes four bottom supports that are positioned along a perimeter of the index wheel and the upper member includes four side supports that are positioned along a perimeter of the index wheel, and
wherein the four bottom supports are respectively aligned with the four side supports.

15. The capping system of claim 11, wherein the capping member is configured to rotate the cap to fasten the cap to the bottle.
